(19) United States
(12) Patent Application Publication
(10) Pub. No.: US 2026/0081503 A1
(43) Pub. Date: Mar. 19, 2026

(54) MECHANISM FOR SECURING A ROTOR

(71) Applicant: ZOELLER PUMP COMPANY, LLC, Louisville, KY (US)

(72) Inventors: Chris KNASTER, Louisville, KY (US); James ERHART, Louisville, KY (US); Jammie FORBIS, Shepherdsville, KY (US); Jeremy CONDER, Louisville, KY (US)

(73) Assignee: ZOELLER PUMP COMPANY, LLC, Louisville, KY (US)

(21) Appl. No.: 19/330,418

(22) Filed: Sep. 16, 2025

Related U.S. Application Data
(60) Provisional application No. 63/695,186, filed on Sep. 16, 2024.

(51) Int. Cl. H02K 7/14; H02K 7/00

(52) U.S. Cl. CPC H02K 7/14; H02K 7/003

(57) ABSTRACT

An improved mechanism for securing a rotor is provided. The rotor may have an end portion with a first surface. The first surface may be threaded. The first surface of the end portion of the rotor may be different than the portion of the rotor not consisting of the end portion. A drive object may have a second surface formed on a face of the drive object to receive the first surface of the rotor. The second surface may be threaded to complement the first surface of the rotor. The drive object and the rotor may be removably affixed by threading the two surfaces together. In some embodiments, the threading on the two surfaces may follow the direction of rotation of the rotor. In some embodiments, the second surface may be made of a material that is softer than the first surface.

### CROSS-REFERENCE TO RELATED APPLICATIONS

This application claims priority to and the benefit of U.S. Provisional Patent Application No. 63/695,186 , filed on Sep. 16, 2024, which is hereby incorporated by reference in its entirety.

### BACKGROUND

### Field

This field is generally related to electric motors.

### Related Art

The rotor and stator are the two main parts of an electric motor, and they work together to convert electrical energy into mechanical energy. Stator and rotor stacks are used in many everyday devices, including electric fans, refrigerators, air conditioners, washing machines, vacuum cleaners, and garage door openers.

The stator is the stationary part of the motor that creates a magnetic field using coils or windings. It is made up of a series of electromagnets arranged in a hollow cylinder. The rotor is the rotating part of the motor that receives electrical energy and converts it into mechanical motion. In electric motors, the rotor is ultimately secured to a drive object driven by the motor via a drive connector. It will now be apparent to one of ordinary skill in the art that any number of appropriate drive connectors may be used as required based on the drive object being coupled to the motor.

Traditionally, rotors have been secured using a pin through the drive connector. The pin is placed through a hole drilled in the rotor with a corresponding hole in the drive connector. However, this is not desirable for several reasons. One, use of the pin connection requires drilling of the shaft and drive connector to allow for the pin's insertion. Two, servicing of a rotor attached to a drive shaft with a pin is cumbersome. For example, additional tools may be required to remove the pin depending on the type of pin used. Also, lubrication provided along the rotor may create conditions where the pin is slippery making difficult to keep the pin in place or remove the pin to service the object or motor. As such, there is a need for new type of connection between a rotor and a drive connector.

### SUMMARY OF INVENTION

In an embodiment, an improved mechanism for securing a rotor is provided. The rotor may have an end portion with a first surface. The first surface may be threaded. The first surface of the end portion of the rotor may be different than the portion of the rotor not consisting of the end portion. A drive object may have a second surface formed on a face of the drive object to receive the first surface of the rotor. The second surface may be threaded to complement the first surface of the rotor. The drive object and the rotor may be removably affixed by threading the two surfaces together. In some embodiments, the threading on the two surfaces may follow the direction of rotation of the rotor. In some embodiments, the second surface may be made of a material that is softer than the first surface.

System, device, and computer program product aspects are also disclosed.

Further features and advantages, as well as the structure and operation of various aspects, are described in detail below with reference to the accompanying drawings. It is noted that the specific aspects described herein are not intended to be limiting. Such aspects are presented herein for illustrative purposes only. Additional aspects will be apparent to persons skilled in the relevant art(s) based on the teachings contained herein.

### DESCRIPTION OF THE DRAWINGS

The accompanying drawings are incorporated herein and form a part of the specification.

FIG. 1 illustrates a prior art embodiment of a rotor using a pin-type connector.

FIG. 2 further illustrate the prior art embodiment illustrated in FIG. 1 via a detailed blowup of the affixed rotor and drive object.

FIG. 3 illustrates the use of a threaded connection between the rotor and the drive object rather than a pin.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for an improved mechanism for securing a rotor.

A rotor and a drive object may be coupled using a threaded connection. The rotor's shaft may have a threaded end and the interior of the drive object may be threaded in a complementary way to allow the two pieces to be coupled. Therefore, the rotor and the drive object may be removably affixed. In some embodiments, the threaded part of the drive object may be a softer material than the rotor's threaded part. In some embodiments, the threading direction may be consistent with the direction of rotation of the rotor to self-tighten the connection between the rotor and the drive object.

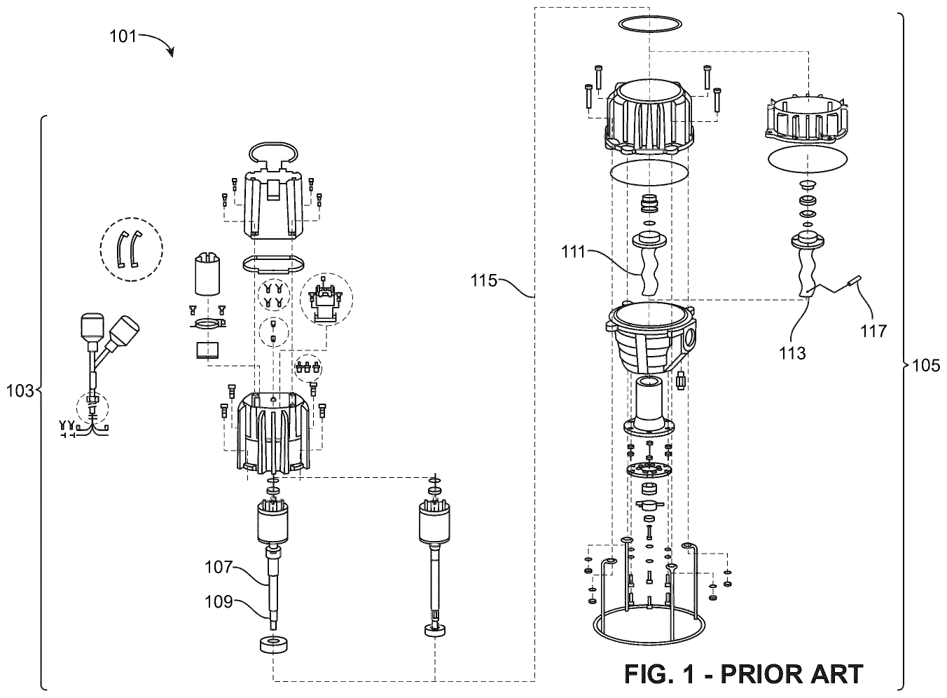

FIG. 1 illustrates a prior art embodiment of a rotor using a pin-type connector. System 101 includes rotor side 103 and impeller side 105.

Rotor side 103 includes rotor 107 which has hole 109 drilled through rotor 107 to allow for the insertion of pin 117.

Impeller side 105 includes an exemplary drive object 111 driven by rotor 107. In this embodiment, drive object 111 is an impeller. However, it will now be apparent to one of ordinary skill in the art that drive object 111 may be any required component for a specific application. Drive object 111 may have a hole 113.

When assembled as illustrated by combination line 115, rotor side 103 and impeller side 105 are combined into a single body, rotor 107 and drive object 111 may be brought together such that hole 109 and hole 113 are aligned. When aligned, hole 109 and hole 113 can receive a pin 117 through both holes and affix rotor 107 and drive object 111 together.

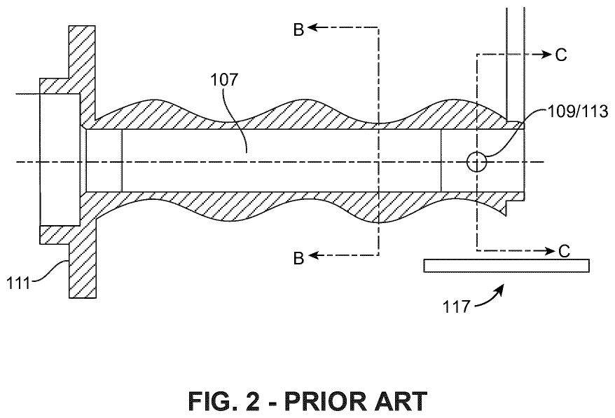

FIG. 2 further illustrates the prior art embodiment illustrated in FIG. 1 via a detailed blowup of the affixed rotor 107 and drive object 111. Hole 109 and hole 113 are aligned and pin 117 can be placed through holes 109 and 113 to affix the rotor 107 and drive object 111 together.

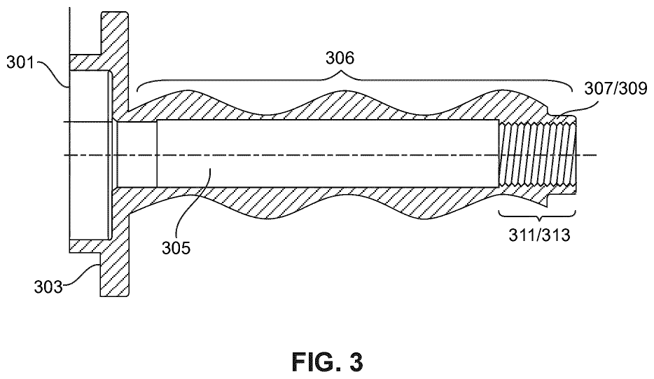

FIG. 3 illustrates the use of a threaded connection rather than a pin. Element 301 includes a drive object 303 and rotor 305 similar to FIGS. 1 and 2.

Drive object 303 may be an object that is rotated by rotor 305. As described above, drive object 303 may include an impeller. An impeller is a rotating disk or hub with vanes or blades attached to it. As the impeller rotates, it moves a fluid (liquid or gas) by imparting pressure on it. In this way, by rotating drive object 303, element 301 may be configured to pump water or other fluids through a channel. Drive object 303 may comprise an end portion 313.

Rotor 305 may be the rotating component of element 301 that produces the mechanical motion. Rotor 305 may be the rotating part of an electric motor. Rotor 305 may be a squirrel-cage rotor. A squirrel-cage rotor includes a cylinder of metal bars which is rotated by a magnetic field generated by the stator coupled to the rotor. Additionally or alternatively, rotor 305 may be a wound rotor. A wound rotor is a type of induction motor where the rotor's windings are connected through slip rings to external resistance.

To rotate drive object 303, rotor 305 may include a shaft 306. Rotor 305 may apply a torque to shaft 306 to rotate drive object 303. Shaft 306 may be a cylindrical component within rotor 305 that transmits the torque from rotor 305 to drive object 303. To transfer the torque from rotor 305 to drive object 303, shaft 306 may be coupled to drive object 303.

To coupled drive object 303 and rotor 305, drive object 303 and rotor 305 may include complementary surfaces 307 and 309 respectively. Rotor surface 309 may be a threaded form on shaft 306. The threaded form may be spiral ridges (called threads) that are cut or formed on the outside (external thread) of shaft 306. Rotor surface 309 may be formed on end portion 311 of rotor 305 and shaft 306.

Drive object surface 307 may be a complementary surface configured to receive end portion 311. Drive object surface 307 may be formed on the interior of drive object 303. Drive object surface 307 may also have a threaded form and it may be complementary in that its threads may have a geometry so that it fits securely onto rotor surface 309. The geometry of drive object surface 307 (and corresponding rotor surface 309) may include a pitch (distance between adjacent thread crests), major/minor diameter (outer and inner diameters of the thread), thread angle (angle of the “V” shape in cross-section), and handedness (right-hand or left-hand twist).

It will now be apparent to one of ordinary skill in the art that the drive object 303 and rotor 305 may become removably affixed. Specifically, in lieu of a pin, drive object 303 and rotor 305 are removably affixed by drive object surface 307 being coupled with rotor surface 309. Removably affixed will be understood by one of ordinary skill in the art as, for example, allowing for drive object 303 to be removed from rotor 305 for servicing or replacement of drive object 303 with a replacement part or different drive object.

Numerous variations of the above embodiment will now be apparent to one of ordinary skill in the art. In an alternative embodiment with respect to FIG. 3, end portion 311 may include rotor surface 309 and drive object surface 307 may be formed in the drive object end portion 313 during fabrication. In this embodiment, the end portion 311 and rotor surface 309 must be sufficiently hard to be able to form a complementary surface in end portion 313 of drive object 303. Alternatively, drive object end portion 313 may be formed of a material softer than rotor end portion 311 or rotor surface 309 such that drive object surface 307 may be formed thereon.

It will also now be apparent to one of ordinary skill in the art that certain thread directions are preferable. For example, if the threading direction is consistent with the rotation of the direction of the object in use, drive object surface 307 and rotor surface 309 are brought closer into contact with each other. In other words, surfaces 307 and 309 may be self-tightening where their thread direction (handedness mentioned above) is the same direction as the rotation of the object. As an example, rotor surface 309 may be right hand oriented, drive object surface 307 configured to receive a right handed orientation thread, and drive object 303 will spin in a direction where drive object surface 307 and rotor surface 309 are brought closer into contact when drive object 303 is in motion.

While this disclosure describes exemplary embodiments for exemplary fields and applications, it should be understood that the disclosure is not limited thereto. Other embodiments and modifications thereto are possible, and are within the scope and spirit of this disclosure. Further, embodiments (whether or not explicitly described herein) have significant utility to fields and applications beyond the examples described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed:

1. A removably affixed drive object and rotor comprising:
a rotor, the rotor having an end portion with a first surface, wherein the first surface of the end portion being different than the portion of the rotor not consisting of the end portion and wherein the first surface is threaded;
a drive object, the drive object have a second surface formed on a face of the drive object to receive the first surface of the rotor, wherein the second surface is threaded to complement the first surface; and
wherein the drive object and the rotor are removably affixed.

2. The removably affixed drive object and rotor of claim 1 wherein the drive object is an impeller.

3. The removably affixed drive object and rotor of claim 1 wherein the rotor rotates in a direction and wherein the first surface is threaded along the direction of rotor's rotation.

4. The removably affixed drive object and rotor of claim 1 wherein the second surface is formed on an interior face of the drive object.

5. The removably affixed drive object and rotor of claim 1 wherein the second surface is formed of a material softer than the first surface.

6. The removably affixed drive object and rotor of claim 1 wherein the rotor is a squirrel-cage rotor.

7. The removably affixed drive object and rotor of claim 1 wherein the rotor is a wound rotor.

8. A method for forming a removably affixed object and rotor, the method comprising:
forming a first surface on a rotor, wherein the first surface is threaded; and
forming a second surface on a drive object,
wherein the second surface is formed in a complementary manner to allow the drive object and rotor to be removably affixed when the first surface is brought into contract with the second surface.

9. The method of claim 8 wherein the drive object is an impeller.

10. The method of claim 8 wherein the rotor rotates in a direction and wherein the first surface is threaded along the direction of rotor's rotation.

11. The method of claim 8 wherein the second surface is formed on an interior face of the drive object.

12. The method of claim 8 wherein the second surface is formed of a material softer than the first surface.

13. The method of claim 8 wherein the rotor is a squirrel-cage rotor.

14. The method of claim 8 wherein the rotor is a wound rotor.

15. A system for an electric motor comprising:
a rotor, the rotor having an end portion with a first surface, wherein the first surface of the end portion being different than the portion of the rotor not consisting of the end portion and wherein the first surface is threaded;
a drive object, the drive object have a second surface formed on a face of the drive object to receive the first surface of the rotor, wherein the second surface is threaded to complement the first surface; and
wherein the drive object and the rotor are removably affixed.

16. The system of claim 15 wherein the drive object is an impeller.

17. The system of claim 15 wherein the rotor rotates in a direction and wherein the first surface is threaded along the direction of rotor's rotation.

18. The system of claim 15 wherein the second surface is formed on an interior face of the drive object.

19. The system of claim 15 wherein the second surface is formed of a material softer than the first surface.

20. The system of claim 15 wherein the rotor is a squirrel-cage rotor.
